(19) United States
(12) Patent Application Publication
(10) Pub. No.: US 2002/0009328 A1
(43) Pub. Date: Jan. 24, 2002

(54) Blot organizer

(75) Inventors: David A. Beckman, Temecula, CA (US); Kathy Nakamura, Temecula, CA (US)

Correspondence Address: Lisa A. Haile, Ph.D., Gray Cary Ware & Freidenrich LLP, Suite 1600, 4365 Executive Drive, San Diego, CA, 92121-2189, US

(73) Assignee: Chemicon International, Inc

(21) Appl. No.: 09/894,847

(22) Filed: Jun. 27, 2001

Related U.S. Application Data
(60) Provisional application No. 60/214,325, filed on Jun. 27, 2000.

(51) Int. Cl. B42F 3/00

(52) U.S. Cl. 402/73

(57) ABSTRACT

The present invention provides organizers for retaining moistened blotting membranes used in biotechnology applications. In a preferred aspect of the invention, the organizer includes a ring binder and a plurality of resealable fluid-tight blot containers that are mountable in the ring binder. In additional aspects of the invention, the organizer further includes bottles to serve as buffer containers, as well as structure for retaining the buffer containers. Invention organizers provide for the storage and user-defined organization of multiple blots in an space-saving format, and further provides for the blots to be maintained in a moistened state, thereby prolonging the life of blotting membranes.

### RELATED APPLICATION DATA

This application is claims the benefit of priority under 35 USC § 119(e) of U.S. application Ser. No. 60/214,325, filed Jun. 27, 2000. The disclosure of the prior application is considered part of and is incorporated by reference in its entirety in the disclosure of this application.

### FIELD OF THE INVENTION

The present invention generally relates to organization systems and more particularly to a notebook for organizing blots generated by a variety of biotechnology techniques.

### BACKGROUND OF THE INVENTION

Research in the field of biotechnology often involves the use of blotting technology to facilitate sorting and characterizing a variety of biological materials, from whole cells to oligonucleotides and small peptides. Briefly, blotting technology involves the transfer, or blotting, of a biological material onto a blotting membrane of material such as nitrocellulose, nylon, or the like. The biological material is then probed with another material that is specific for a target material whose presence is sought to be determined. Binding of the probe to its cognate target can be determined by employing labeled probing material. Detection of labeled probe on the blotting membrane, after a series of defined wash steps, indicates presence of the target material.

Storage of a blot is often required, whether due to processing limitations or the desire to probe a blot with more than one type of probe at a later date. Due to the fragile nature of some blotting membranes, it is often advantageous to store a blot under conditions that allow it to remain moist. This is most often accomplished by leaving the blots in a dish containing buffer, however, space constraints in most laboratories, and the need to organize large numbers of blots has revealed the inadequacies of this and other piecemeal organization and preservation systems.

Accordingly, there is still a need in the art for a system to organize and preserve blots in a manner that enables their repeated use and efficient storage.

### BRIEF DESCRIPTION OF THE INVENTION

The present invention overcomes many of the problems in the art by providing a notebook or other similar filing system that is configured to retain blotting membranes in an appropriate liquid medium.

Thus, in one embodiment of the present invention, there are provided organizers that include a plurality of fluid-tight blot containers and a binder and wherein the fluid-tight blot containers can be retained by said binder.

In a preferred embodiment, the fluid-tight blot containers are resealable polymer bags.

### DETAILED DESCRIPTION OF THE INVENTION

Invention organizers provide a way to store and organize blots for later use and/or reuse. Because blots are flat, in one embodiment of the present invention, the organizer is substantially flat, and has a plurality of containers for storing the blotting membrane. Thus, invention organizers comprise both blot containers for storing the blotting membranes and a structure for retaining the blot containers in a user-defined order. Structure for retaining the blot containers can comprise any of a number of suitable structures, including, but not limited to, a box, a folder and a binder. A presently preferred structure is the well-known ring binder, e.g., a three ring binder, or the like. Binders having retention devices other than rings, e.g., clips, or the like, are also contemplated for use in the practice of the present invention.

Because invention organizers will be used in conjunction with the handling of blotting membranes, in another embodiment of the present invention, the binder comprises structure for retaining blot handling hardware. The most likely blot handling hardware is a pair of tweezers; thus, in a preferred aspect of this embodiment, the structure for retaining blot handling hardware is a retention loop or other suitable structure for retaining a pair of tweezers. In a further aspect of this embodiment, blot handling hardware is also provided. Blot handling hardware may include a pair of tweezers such as Glass-filled Delrin tweezers available from Ted Pella, Inc. (part No. 53009), for example.

Because blots are most advantageously stored in a liquid medium, usually a buffered aqueous medium, invention organizers include fluid-tight blot containers for maintaining blotting membranes in a moistened state. In a preferred embodiment, the blot containers are sealable. In a most preferred embodiment, the blot containers have a reusable sealing mechanism such as a zipper, or the like, and are constructed of a polymer that is compatible with reagents commonly used with blotting technology. Such polymers include polyethylene and saranex. One example of suitable blot containers are the 3 mil BITRAN™ Leak Proof Zipper Bags available from Associated Bag Company.

Blot containers will be mountable in the structure for retaining the blot containers, e.g., ring-binder. This is most advantageously accomplished by providing dividers that have an adhesive strip for attaching blot containers. Thus, the adhesive strip will comprise an adhesive of sufficient strength to retain a resealable bag such as the BITRAN™ Leak Proof Zipper Bag, when the bag contains a moistened blot. The divider further comprises structure, e.g., holes, for mounting the divider in a binder. In another embodiment, the blot container itself has mounting structure, e.g., a holes, for mounting the container directly in a binder. Of course, the mounting structure must be configured so as to not compromise the fluid-tight nature of the blot container.

It is often advantageous to have additional buffer available to remoisten a blotting membrane as required, whether due to drying of the membrane over time, or the reuse of a particular membrane. Thus, in another embodiment of the present invention, the organizer further comprises slotted structure for retaining reagent bottles that can contain additional buffer. In one aspect of this embodiment, the slotted structure is mounted on the inside cover of a ring binder. In another aspect, the slotted structure is provided with attachment points for mounting the structure on the rings of a ring binder. In still another aspect of this embodiment, the organizer further comprises reagent bottles suitable for containing buffer. Suitable reagent bottles are widely available and well-known to those of skill in the art. One example of such a container is the Nalgene 15 ml high-density polyethylene (HDPE) bottle, catalog no. 2002-9050.

While the invention has been described in detail with reference to certain preferred embodiments thereof, it will be understood that modifications and variations are within the spirit and scope of that which is described and claimed.

What is claimed is:

1. An organizer comprising a plurality of fluid-tight containers and a binder, and wherein the fluid-tight containers can be retained by said binder.

2. An organizer according to claim 1, wherein the binder is a ring binder.

3. An organizer according to claim 1, wherein the fluid-tight containers comprise sealable polymer bags.

4. An organizer according to claim 3, wherein the sealable polymer bags comprise structure for mounting the bag in the binder.

5. An organizer according to claim 3, further comprising dividers having an adhesive strip for mounting the sealable polymer bags.

6. An organizer according to claim 3, wherein the sealable polymer bags have a reusable sealing mechanism.

7. An organizer according to claim 6, wherein the reusable sealing mechanism comprises a zipper.

8. An organizer according to claim 1, wherein at least one of the fluid-tight containers is a polymer bottle.

9. An organizer according to claim 8, wherein at least one of the fluid-tight containers is a sealable polymer bag.

10. An organizer according to claim 8, wherein the structure for retaining the containers comprises a plurality of slots for receiving the bottles therein.

11. An organizer according to claim 10, wherein the plurality of slots is integral to a cover of the binder.

12. An organizer according to claim 10, wherein the plurality of slots is integral to a divider that is mountable in the binder.

13. An organizer according to claim 1, further comprising structure for retaining blot manipulation hardware.

14. An organizer according to claim 1, further comprising blot manipulation hardware.

15. An organizer according to claims 13 and 14, wherein the hardware comprises tweezers.

16. An organizer according to claim 15, wherein the structure is a retention loop mounted to an inside cover of the binder.
